(19) United States
(12) Patent Application Publication
(10) Pub. No.: US 2015/0178782 A1
(43) Pub. Date: Jun. 25, 2015

(54) PRIVILEGE PROVIDING DEVICE AND PRIVILEGE PROVIDING METHOD

(71) Applicants: Goeun Kim, Abiko-city (JP); Kenichi Mogi, Shibuya-ku (JP)

(72) Inventors: Goeun Kim, Abiko-city (JP); Kenichi Mogi, Shibuya-ku (JP)

(73) Assignee: HUGG Inc., Tokyo (JP)

(21) Appl. No.: 14/412,519

(22) PCT Filed: Jul. 4, 2012
(86) PCT No.: PCT/JP2012/067121

§ 371 Date: Feb. 11, 2015

(51) Int. Cl. G06Q 30/02

(52) U.S. Cl. CPC G06Q 30/0267

(57) ABSTRACT

A distribution server includes a coupon database for storing a coupon that indicates a privilege for receiving a benefit, the privilege being provided for a mobile terminal, and a coupon transmission section for sending a split coupon obtained by dividing the coupon by the number of mobile terminals to each of the mobile terminals in order to allow a privilege indicated by a ticket, coupon, or the like to be provided for a plurality of users.

### TECHNICAL FIELD

The present invention relates to a privilege providing device and a privilege providing method.

### BACKGROUND ART

With the popularization of the Internet, various tickets, coupons and so forth are electronically issued. Patent Literature 1 discloses that coupon usage history of a user is analyzed and the coupon of a target commodity is preferentially presented at the next purchase time such that the user can easily acquire a desired coupon.

### CITATION LIST

### Patent Literature

Patent Literature 1: Japanese Patent Laid-Open No. 2011-243041

### SUMMARY OF INVENTION

### Technical Problem

There is a situation in which it is desired to provide a commodity, service, or a special favor using a group of multiple users as a unit, like a pair sheet of a movie theater and a table of a restaurant, and so on. In the related art, however, the issue of an electronic ticket, an electronic coupon, or the like is premised on the distribution to each individual user, and it is not possible to distribute such a coupon to a target group.

The present invention is made in view of such a background, and it is an object to provide a privilege providing device and privilege providing method that can provide to multiple users a privilege expressed by a ticket, a coupon and so forth.

### Solution to Problem

The main invention of the present invention to solve the above-mentioned problem is a privilege providing device for providing a privilege to be given to multiple users, including: a privilege information storage unit configured to store privilege information that is information to express the privilege to be given to the users; and a privilege information transmission unit configured to transmit to each of user terminals of the users divided information into which the privilege information is divided according to a number of the users.

Moreover, the privilege providing device of the present invention may further include: a notification transmission unit configured to transmit to the user terminals a notification to give the privilege to the users; and a reception request receiving unit configured to receive reception requests of the privilege, the reception requests transmitted from the user terminals in response to the notification, wherein the privilege information transmission unit specifies reception terminals that are the user terminals having transmitted the reception requests, divides the privilege information according to a number of the reception terminals, and transmits the divided information only to the reception terminals.

Moreover, in the privilege providing device of the present invention, the privilege information transmission unit may transmit the divided information only when the number of the reception terminals is equal to or greater than a predetermined number.

Moreover, in the privilege providing device of the present invention, the privilege information storage unit may store the privilege information that varies according to a division number, and the privilege information transmission unit may read out the privilege information corresponding to the number of the reception terminals from the privilege information storage unit and divide the read privilege information according to the number of the reception terminals.

Moreover, in the privilege providing device of the present invention, positions of the user terminals may be included in the reception requests, and the privilege information transmission unit may determine whether the positions included in the reception requests are included in a predetermined range based on a predetermined position, and specify, among the user terminals having transmitted the reception requests, the user terminals whose positions are included in the predetermined range as the reception terminals.

Moreover, in the privilege providing device of the present invention, the privilege information transmission unit may transmit a whole of the privilege information only to one first user terminal among the multiple user terminals, and transmit a message to give an instruction to view the privilege information displayed to the first user terminal, to a second user terminal different from the first user terminal.

Moreover, the privilege providing device of the present invention may further include: a notification transmission unit configured to transmit to each of the user terminal a notification to give the privilege; and a reception request receiving unit configured to receive reception requests of the privilege, the reception requests being transmitted from the user terminals in response to the notification and including positions of the user terminals, wherein the privilege information transmission unit determines whether the positions included in the reception requests are included in a predetermined range based on a position of a first user terminal, and specifies, among the user terminals having transmitted the reception requests, the user terminals whose positions are included in the predetermined range as the reception terminals.

Another mode of the present invention is a method of providing a privilege to multiple user terminals, the method comprising steps executed by a computer of: storing privilege information that is information to express the privilege to be provided to the user terminals; and transmitting to each of the user terminals without duplication divided information into which the privilege information is divided according to a number of the user terminals.

Other problems and solutions thereof disclosed in the present application are clarified in the Description of Embodiment and the drawings.

### Advantageous Effects of Invention

According to the present invention, it is possible to provide to multiple users a privilege expressed by a ticket, a coupon and so forth.

### BRIEF DESCRIPTION OF DRAWINGS

FIG. 1 is a diagram illustrating a configuration example of a coupon distribution system according to an embodiment of the present invention.

FIG. 2 is a diagram illustrating a hardware configuration example of a mobile terminal 10.

FIG. 3 is a diagram illustrating a software configuration example of the mobile terminal 10.

FIG. 4 is a diagram illustrating a hardware configuration example of a distribution server 20.

FIG. 5 is a diagram illustrating a software configuration example of the distribution server 20.

FIG. 6 is a diagram illustrating a configuration example of group information stored in a group database 241.

FIG. 7 is a diagram illustrating a configuration example of coupon information stored in a coupon database 242.

FIG. 8 is a diagram to describe the flow of coupon distribution processing performed in a coupon distribution system of the embodiment.

FIG. 9 is a diagram to describe a state in which a coupon notification receiving unit 121 displays a notification message.

FIG. 10 is a diagram illustrating one example of a screen 51 on which a notification message 511 is displayed.

FIG. 11 is a diagram illustrating one example of the screen 51 on which the notification message 511 is displayed.

FIG. 12 is a diagram illustrating one example of a screen 52 after the transmission of a coupon reception request.

FIG. 13 is a diagram to describe the flow of coupon issue processing.

FIG. 14 is a diagram illustrating an example of screens 531 and 532 displayed to two mobile terminals 10.

FIG. 15 is a diagram illustrating an example where part of a coupon is displayed on three mobile terminals 10 respectively.

FIG. 16 is a diagram illustrating an example where, among three mobile terminals 10, the entire coupon is displayed on the one of the representative user and the content of the coupon is not displayed on the other mobile terminals 10 at all.

### DESCRIPTION OF EMBODIMENTS

### ==Outline==

In the following, a coupon distribution system according to an embodiment of the present invention is described. The coupon distribution system of the present embodiment is designed to distribute a coupon to multiple users and is designed such that, by dividing a coupon and distributing divided coupons (hereinafter referred to as “divided coupons”) to the respective users, a special benefit according to the coupon cannot be received unless the multiple users cooperate. The coupon distributed in the coupon distribution system of the present embodiment denotes information in which the privilege to receive a special benefit such as the discount of a commodity or service is expressed.

### ==System Configuration==

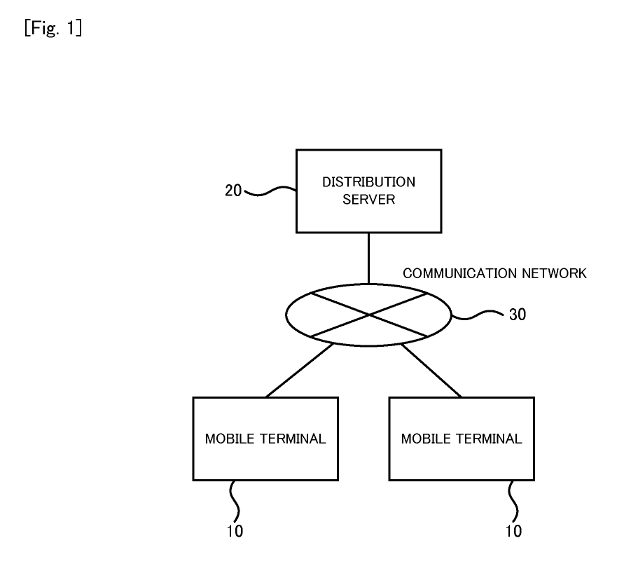

FIG. 1 is a diagram illustrating a configuration example of a coupon distribution system according to the present embodiment. The coupon distribution system of the present embodiment is configured including multiple mobile terminals 10 and the distribution server 20.

The mobile terminal 10 is a computer operated by a user. In the present embodiment, as the mobile terminal 10, there is assumed a device such as a so-called smartphone and tablet computer that perform input and output through a touch panel display.

The distribution server 20 is a computer such as for example a personal computer and a work station which distributes a coupon. In the present embodiment, the distribution server 20 creates a divided coupon and transmits it to the mobile terminal 10.

The mobile terminal 10 and the distribution server 20 are connected so as to be able to perform communication through a communication network 30. The communication network 30 includes, for example, the Internet, a LAN (Local Area Network) and a VAN (Value Added Network), and so on, which are configured with, for example, a public telephone network, a mobile phone network, Ethernet (registered trademark) and a radio channel, and so on. In the present embodiment, it is assumed that communication is performed by TCP/IP in the communication network 30.

### ==Configuration of Mobile Terminal 10==

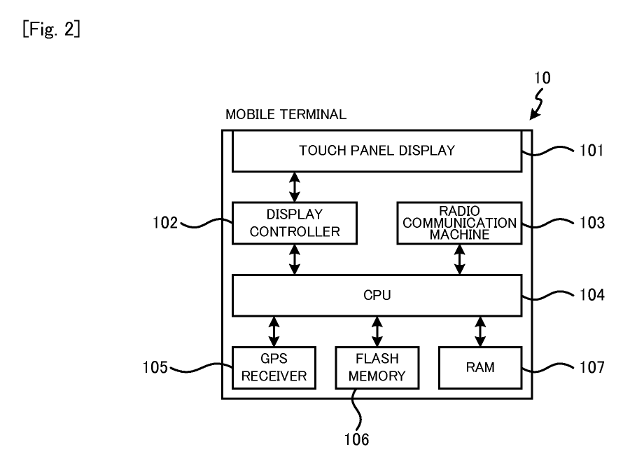

FIG. 2 is a diagram illustrating a hardware configuration example of the mobile terminal 10. The mobile terminal 10 includes a touch panel display 101, a display controller 102, a radio communication machine 103, a CPU (Central Processing Unit) 104, a GPS (Global Positioning System) receiver 105, a flash memory 106 and a RAM (Random Access Memory) 107. The flash memory 106 is a storage device that stores various kinds of data and programs. A storage device such as a hard disk drive and a solid-state drive may be adopted instead of the flash memory 106. The CPU 104 implements various functions by reading out and executing a program stored in the flash memory 106, in the RAM 107. The GPS receiver 105 is a receiver that receives a positioning signal from a GPS satellite. The display controller 102 detects the display of information in the touch panel display 101 or the touch and swipe, and so on, of a finger in the touch panel display 101 and accepts an input of data from the user.

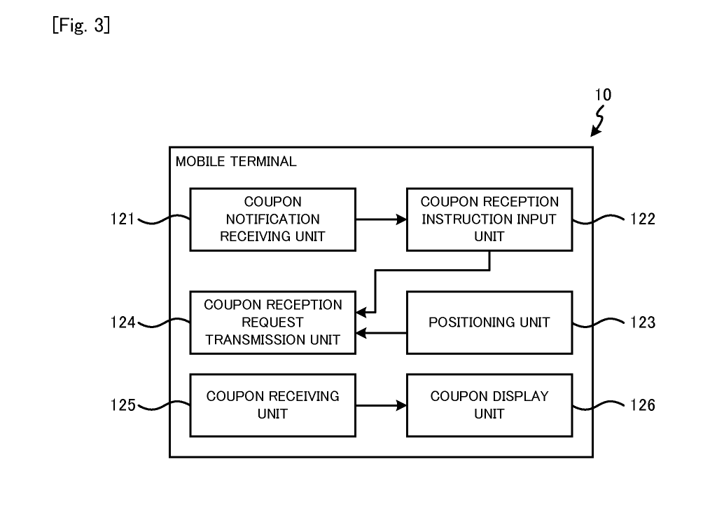

FIG. 3 is a diagram illustrating a software configuration example of the mobile terminal 10. The mobile terminal 10 includes a coupon notification receiving unit 121, a coupon reception instruction input unit 122, a positioning unit 123, a coupon reception request transmission unit 124, a coupon receiving unit 125 and a coupon display unit 126. The coupon notification receiving unit 121, the coupon reception instruction input unit 122, the positioning unit 123, the coupon reception request transmission unit 124, the coupon receiving unit 125 and the coupon display unit 126 are implemented by the CPU 104 included in the mobile terminal 10 reading out and executing a program stored in the flash memory 106, in the RAM 107.

The coupon notification receiving unit 121 receives notification to issue a coupon (hereafter referred to as “coupon notification”), from the distribution server 20. The coupon notification includes information showing the issued coupon (hereafter referred to as “coupon ID”) and a message related to the coupon (hereafter referred to as “notification message”).

The coupon reception instruction input unit 122 accepts an instruction as to whether the user receives the coupon. The coupon reception instruction input unit 122 displays the notification message received by the coupon notification receiving unit 121 on the touch panel display 101 to notify to the user that the coupon is issued, and accepts an input as to whether to receive the coupon.

The positioning unit 123 measures the current position of the mobile terminal 10. It is assumed that the positioning unit 123 measures the current position of the mobile terminal 10 on a map by a well-known technique on the basis of a positioning signal received by the GPS receiver 105. For example, the current position measured by the positioning unit 123 is expressed by latitude and longitude.

The coupon reception request transmission unit 124 transmits a request of the coupon (hereafter referred to as “coupon reception request”) to the distribution server 20. In the coupon reception request, the coupon ID included in the coupon notification, the user ID showing the user of the mobile terminal 10 and the current position of the mobile terminal 10 measured by the positioning unit 123 are set.

The coupon receiving unit 125 receives a coupon transmitted from the distribution server 20. As described above, the coupon received by the coupon receiving unit 125 is a divided coupon into which an issued coupon is divided. Here, as described later, there is a case where the entire coupon is transmitted only to the mobile terminal 10 of the representative user of the group as a divided coupon and an empty divided coupon is transmitted to other mobile terminals 10, and, in this case, a message to see the coupon of the representative user is displayed on other mobile terminals 10.

The coupon display unit 126 displays the coupon received by the coupon receiving unit 125. The coupon display unit 126 turns out to display the divided coupon. When each of the mobile terminals 10 belonging to the group displays the divided coupon, the whole of the coupon is displayed as a whole.

### ==Configuration of Distribution Server 20==

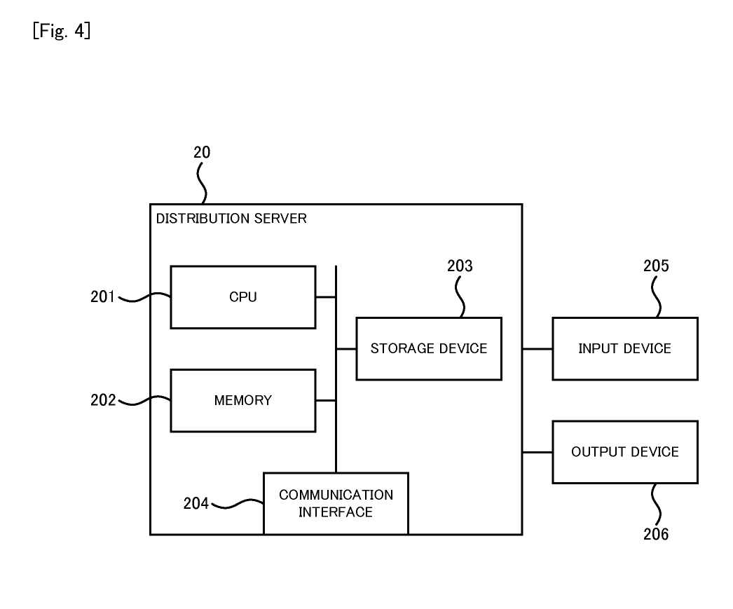

FIG. 4 is a diagram illustrating a hardware configuration example of the distribution server 20. The distribution server 20 includes a CPU 201, a memory 202, a storage device 203, a communication interface 204, an input device 205 and an output device 206. The storage device 203 is, for example, a hard disk drive, a solid-state drive, or a flash memory, which stores various kinds of data and programs. The CPU 201 implements various functions by reading out and executing a program stored in the storage device 203, in the memory 202. The communication interface 204 is an interface to connect with the communication network 30, and is, for example, an adaptor to connect with Ethernet (registered trademark), a modem to connect with a public telephone network, or a radio communication machine to connect with a radio communication network. The input device 205 is, for example, a keyboard, a mouse, a track ball, a touch panel, or a microphone, which accepts an input of data. The output device 206 is, for example, a display, a printer, or a speaker, which outputs data. The distribution server 20 can be designed to include multiple input devices 205 and output devices 206.

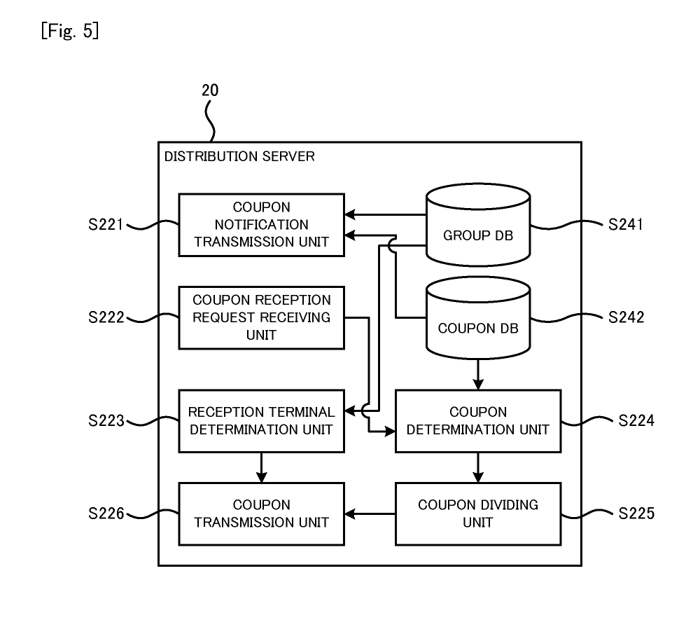

FIG. 5 is a diagram illustrating a software configuration example of the distribution server 20. The distribution server 20 includes a coupon notification transmission unit 221, a coupon reception request receiving unit 222, a reception terminal determination unit 223, a coupon determination unit 224, a coupon dividing unit 225, a coupon transmission unit 226, the group database 241 and the coupon database 242. The coupon notification transmission unit 221, the coupon reception request receiving unit 222, the reception terminal determination unit 223, the coupon determination unit 224, the coupon dividing unit 225 and the coupon transmission unit 226 are implemented by the CPU 201 included in the distribution server 20 reading out and executing a program stored in the storage device 203 in the memory 202, and the group database 241 and the coupon database 242 are implemented as parts of storage areas provided by the memory 202 and the storage device 203.

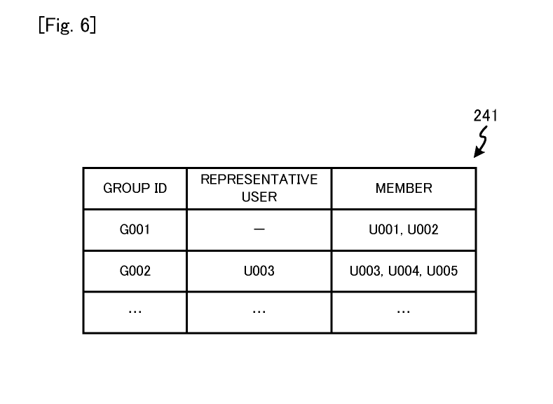

The group database 241 stores information on the group (hereafter referred to as “group information”). FIG. 6 is a diagram illustrating a configuration example of the group information stored in the group database 241. The group information includes the group ID identifying the group, the user ID identifying the user who represents the group (representative user), and the user ID showing members belonging to the group. In a case where the representative user is not set to the group, “-” is set to the representative user. Multiple user IDs are set to the members.

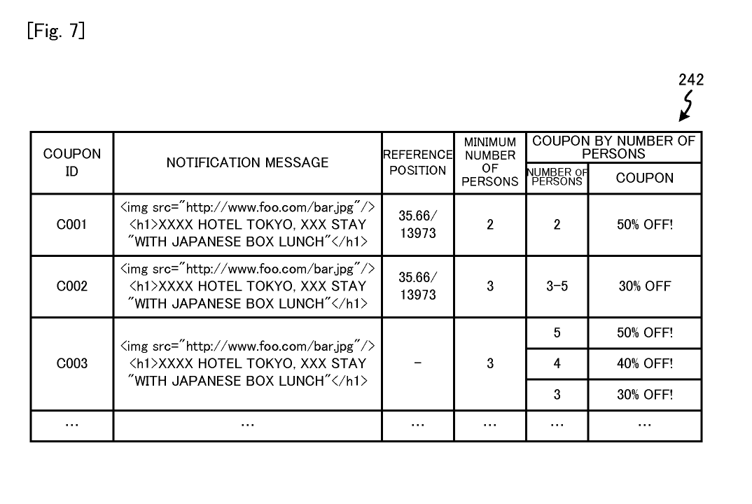

The coupon database 242 stores information including a coupon (hereinafter referred to as “coupon information”). FIG. 7 is a diagram illustrating a configuration example of the coupon information stored in the coupon database 242. The coupon information includes a notification message, a reference position, the minimum number of persons, the number of persons and a coupon by the number of persons, in association with the coupon ID. The notification message is a message showing that a coupon is issued to the user. For example, the notification message can be written by HTML (Hyper Text Markup Language). The reference position is a position that becomes a base to determine a range to decide that the users are in the same place (hereafter referred to as “determination range”), and can be expressed by latitude and longitude. As described later, multiple users have to be in the same place to cause a coupon to be issued, and, for example, the determination range can be assumed to be a range within a predetermined distance from the reference position. In a case where “-” is set to the reference position, the determination range is determined with reference to the current position of the representative user. Moreover, in a case where “-” is set to the reference position and “-” is set to the representative user of the group information, the determination range is determined on the basis of the current position of the user included in the members. The minimum number of persons is the number of persons who use the coupon, which is required to issue a coupon. As described later, the coupon is issued only in a case where the number of mobile terminals 10 having transmitted a coupon reception request in the determination range exceeds the minimum number of persons. A coupon by the number of persons includes a coupon associated with the number of persons. The coupon by the number of persons can include multiple coupons. By this means, coupons of different content according to the number of persons who use the coupon can be registered.

The coupon notification transmission unit 221 transmits a coupon notification to the mobile terminal 10. The coupon notification transmission unit 221 accepts the designation of the coupon ID associated with a coupon to distribute and a group to be a notification destination, reads out group information on the specified group from the group database 241, reads out coupon information corresponding to designated coupon ID from the coupon database 242, and transmits a coupon notification in which the coupon ID and notification message of the read coupon information are set, to the mobile terminal 10 of the user specified by the user ID included in the members of the read group information. Here it is assumed that the mobile terminal 10 can be specified from the user ID by, for example, making the user ID be an email address and so forth.

The coupon reception request receiving unit 222 receives a coupon reception request transmitted from the mobile terminal 10 in response to the coupon notification. The reception terminal determination unit 223 determines the mobile terminal 10 to which a coupon is issued. Among the mobile terminals 10 having transmitted the coupon reception request, the reception terminal determination unit 223 of the present embodiment determines the one as a reception terminal whose current position is included in the determination range.

The coupon determination unit 224 determines a coupon distributed to the mobile terminal 10. It is assumed that the coupon determination unit 224 acquires a coupon corresponding to the number of reception terminals from the coupon database 242 in the present embodiment, but, for example, a rule to create a coupon may be stored so as to create a coupon according to the rule.

The coupon dividing unit 225 creates the divided coupons by dividing the coupon determined by the coupon determination unit 224, according to the number of reception terminals. The division of the coupon can be performed by an arbitrary technique. For example, the coupon dividing unit 225 may extract a character string by an integral number of characters which is the entire character number of the coupon divided by the number of reception terminals, assign it to each reception terminal and assign the remaining characters to the last reception terminal. Moreover, the coupon dividing unit 225 may store division information showing a position in the coupon to divide according to the division number and perform division according to the division information, or may insert a character showing a predetermined divisional position into the coupon and perform division in the position. The divided coupon is transmitted to the reception terminal by the coupon transmission unit 226.

### ==Distribution Processing of Coupon==

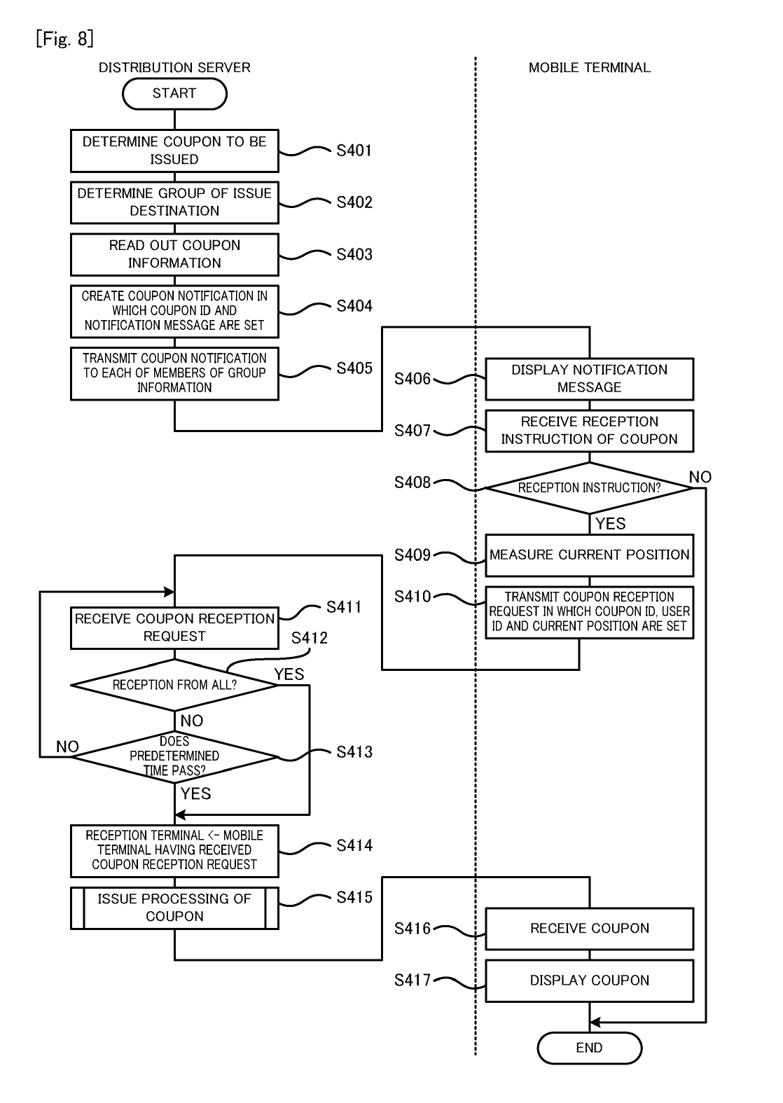

FIG. 8 is a diagram to describe the flow of coupon distribution processing performed in a coupon distribution system of the present embodiment.

First, in the distribution server 20, the coupon notification transmission unit 221 determines a coupon to be issued (S401). The coupon notification transmission unit 221 may, for example, accept an input of the coupon ID from an operator or select coupon information at random. Moreover, the issue date and time may be included in coupon information and coupon information that is not distributed yet before the current date and time may be determined. Next, the coupon notification transmission unit 221 determines a group as issue destination (S402). The coupon notification transmission unit 221 may, for example, accept an input of the group ID from the operator or select group information at random. Moreover, making the group information include the attribute of the group and making the coupon include the attribute of a target commodity (including service), the one having high attribute association may be selected.

The coupon notification transmission unit 221 reads out coupon information corresponding to the coupon ID from the coupon database 242 (S403), creates a coupon notification in which the coupon ID and notification message included in the read coupon information are set (S404), and, regarding each of user IDs included in the members of the group information, transmits the coupon notification to mobile terminals 10 of users shown by the user IDs (S405). For example, in a case where the user ID is an email address, the coupon notification transmission unit 221 can transmit the coupon notification by email addressed to the user ID. Moreover, a user information storage unit that stores the address (information that becomes destination in an arbitrary communication protocol such as email, chat and short message service) of the mobile terminal 10 corresponding to the user ID may be installed, and a destination address may be acquired from the user information storage unit.

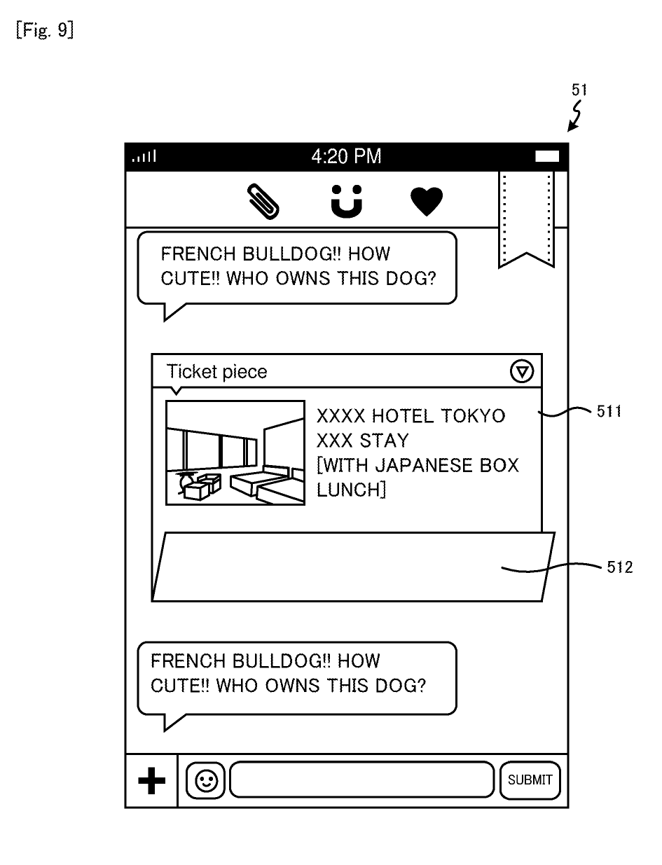

The coupon notification receiving unit 121 of the mobile terminal 10 displays the notification message included in the coupon notification received from the distribution server 20 (S406). FIG. 9 is a diagram to describe a state where the coupon notification receiving unit 121 displays the notification message. As an example, the screen 51 is a screen example in a state where a coupon notification 511 is displayed during the execution of a messenger program. In the present embodiment, it is assumed that there is a group of two (or three or more) users who are performing a chat by the use of the messenger program and the coupon notification is transmitted to both of them at the same time. As illustrated in FIG. 9, only part of the notification message is displayed on the screen 51. In the example of FIG. 9, only the upper part is displayed by performing display such that a coupon ticket is shifted and bent.

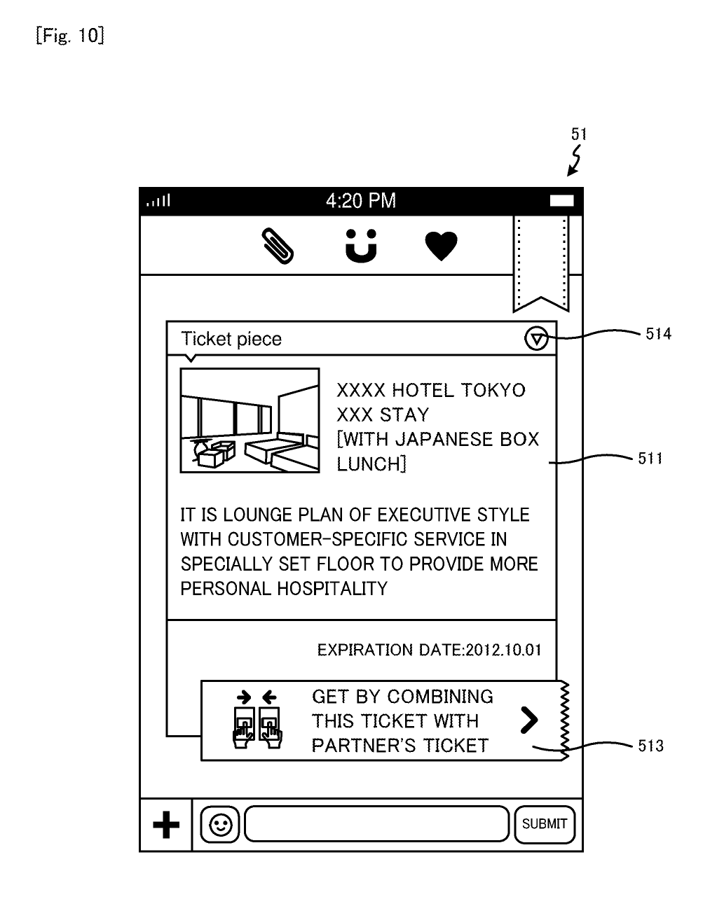

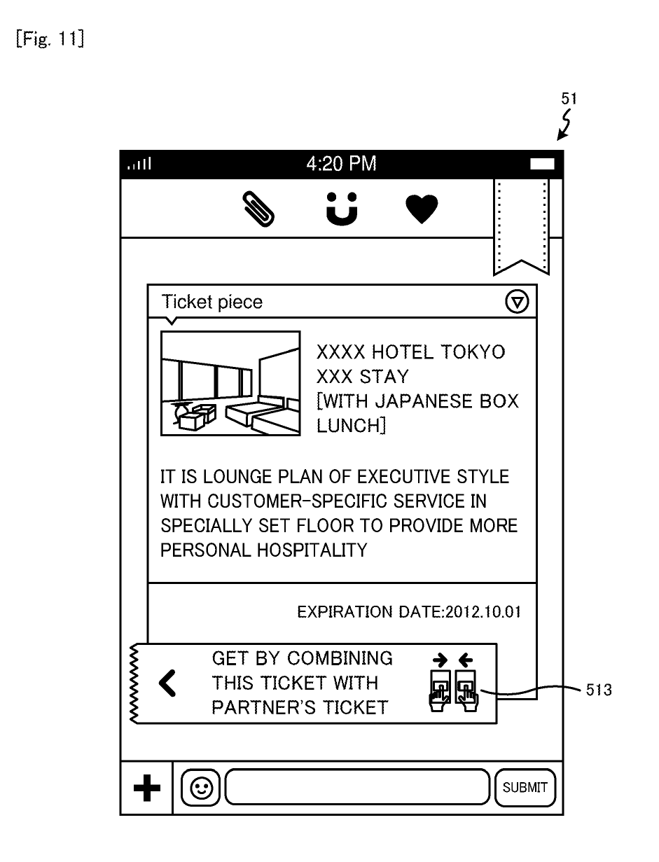

When a graphic 512 that covers the lower part of the notification message is tapped in the screen 51, the whole of the notification message 511 is displayed as illustrated in FIG. 10, and a slider 513 to accept an instruction to receive a coupon is displayed on the lower part of the notification message 511. When a swipe is performed on the touch panel display 101 on the slider 513 and the slider 513 is slid in a horizontal direction, an instruction to receive the coupon turns to be input. In a case where there are two members in a group, the slider 513 to give an instruction to perform a swipe to the right as illustrated in FIG. 10 is displayed for one user while the slider 513 to give an instruction to perform a swipe to the left as illustrated in FIG. 11 is displayed for the other user. By this means, it is possible to guide the users to perform a swipe so as to physically arrange the mobile terminals 10.

When the slider 513 has been slid, the coupon reception instruction input unit 122 accepts an input to receive the coupon (S407). Here, in a case where the slider 513 is not slid within a predetermined time, the coupon reception instruction input unit 122 can determine that an input not to receive the coupon is performed. Moreover, when an icon 514 is tapped, it may be determined that an input not to receive the coupon is performed. The positioning unit 123 measures the current position of the mobile terminal 10 (S409), and the coupon reception request transmission unit 124 transmits to the distribution server 20 a coupon reception request in which the coupon ID included in the coupon notification, the user ID showing the user of the mobile terminal 10 and the current position of the mobile terminal 10 measured by the positioning unit 123 are set (S410).

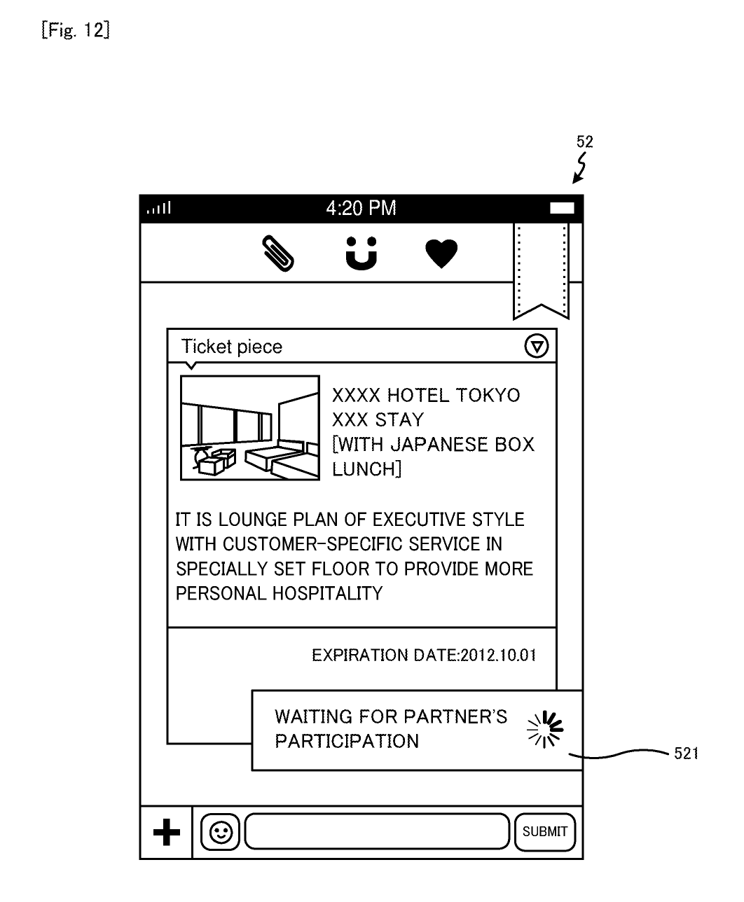

In the distribution server 20, the coupon reception request receiving unit 222 receives the coupon reception request transmitted from the mobile terminal 10 (S411). If the coupon reception request is not received from all mobile terminals 10 to which the coupon notification is transmitted in step S405 (S412: NO), the step proceeds to step S411 and waits for the coupon reception request from the mobile terminal 10 until the lapse of a predetermined time (S413: NO). As described above, in the coupon distribution system of the present embodiment, since the coupon is not issued until the coupon reception request is received from mobile terminals 10 corresponding to the minimum number of persons or more in the same place, a standby screen 52 as illustrated in FIG. 12 is displayed on the mobile terminal 10 until the coupon reception request is received from all mobile terminals 10 to which the coupon notification is transmitted or the above-mentioned predetermined time is lapsed. In the example of the standby screen 52 in FIG. 12, a message 521 to give an instruction to wait until the time other partners (other members belonging to the group) transmit the coupon reception request is displayed.

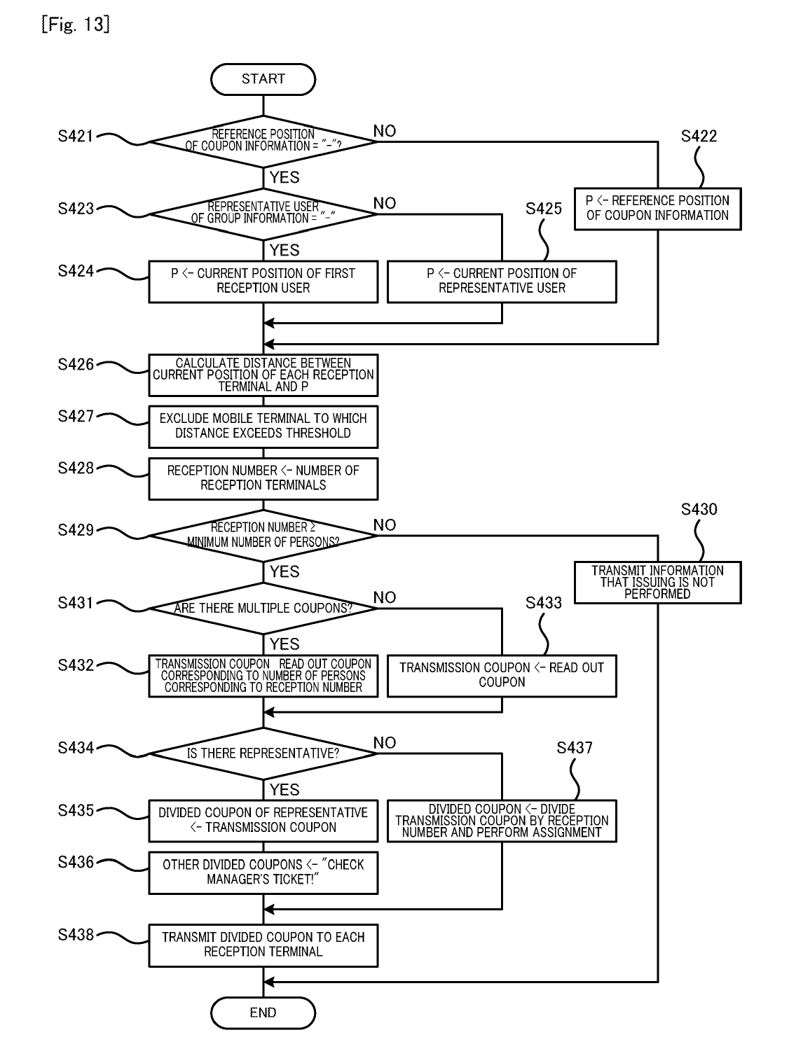

In a case where the coupon reception request is received from all mobile terminals 10 to which the coupon notification is transmitted (S412: YES) or the above-mentioned predetermined time passes (S413: YES), the reception terminal determination unit 223 determines the mobile terminals 10 whose coupon reception request is received, as reception terminals that are to be issue destination of the coupon (S414), and performs coupon issue processing illustrated in FIG. 13 (S415).

In a case where a reference position is set to coupon information (S421: NO), the reception terminal determination unit 223 assumes the reference position of the coupon information to be P (S423). In a case where the reference position of the coupon information is “-” (S421: YES), if the representative user of group information is “-” (S423: YES), the reception terminal determination unit 223 assumes the current position set to the firstly received coupon reception request to be P (S424), but if the user ID is set to the representative user of the group (S423: NO), the reception terminal determination unit 223 assumes the current position set to the coupon reception request received from the mobile terminal 10 of the representative user (that is, user shown by the user ID set to the representative user of the group information) to be P (S425). Here, in a case where the coupon reception request is not received from the mobile terminal 10 of the representative user, processing may be ended without issuing the coupon.

Regarding each of the reception terminals, the reception terminal determination unit 223 calculates the distance between the current position included in the coupon reception request received from the reception terminal and P (S426), and excludes the mobile terminal 10 in which the distance exceeds a predetermined threshold from the reception terminals (S427). By this means, only the mobile terminal 10 whose current position is included in the determination range can be identified as a reception terminal. The reception terminal determination unit 223 counts the number of reception terminals narrowed in this way as the reception number (S428).

In a case where the reception number is less than the minimum number of persons of the coupon information (S429: NO), the coupon transmission unit 226 transmits to the reception terminals a message that a coupon is not issued (S430). On the other hand, in a case where the reception number is equal to or greater than the minimum number of persons of the coupon information (S429: YES), if multiple coupons by the number of persons are included in the coupon information (S431: YES), the coupon determination unit 224 extracts a coupon corresponding to the reception number from the coupon information and assumes it to be a transmission coupon (S432), and, if only one coupon is included in the coupon information (S431: NO), it determines the coupon as a transmission coupon (S433).

In a case where the representative user is set to the group information (S434: YES), the coupon dividing unit 225 determines the whole of the transmission coupon as a divided coupon corresponding to the user ID shown by the representative user (S435) and determines a message to give an instruction to refer to the coupon of the representative user (for example, message “Check manager's ticket!”) as a divided coupon corresponding to other reception terminals than the reception terminal of the representative user (S436). On the other hand, in a case where the representative user is not set to the group information, (S434: NO), the coupon dividing unit 225 determines the divided coupon assigned to each reception terminal by dividing the transmission coupon by the reception number (S437). The coupon dividing unit 225 can, for example, assign characters to the reception terminals in order from the head of the transmission coupon and assign the all remaining characters to the last reception terminal. For example, in a case where coupon “30% OFF!” is assigned to three reception terminals, “30” is assigned to the first reception terminal, “%” is assigned to the second reception terminal, and “OFF!” is assigned to the third reception terminal. Here, it is assumed that the coupon dividing unit 225 assigns the divided coupons to the reception terminals without duplication. The coupon transmission unit 226 transmits the assigned divided coupons to respective reception terminals (S438).

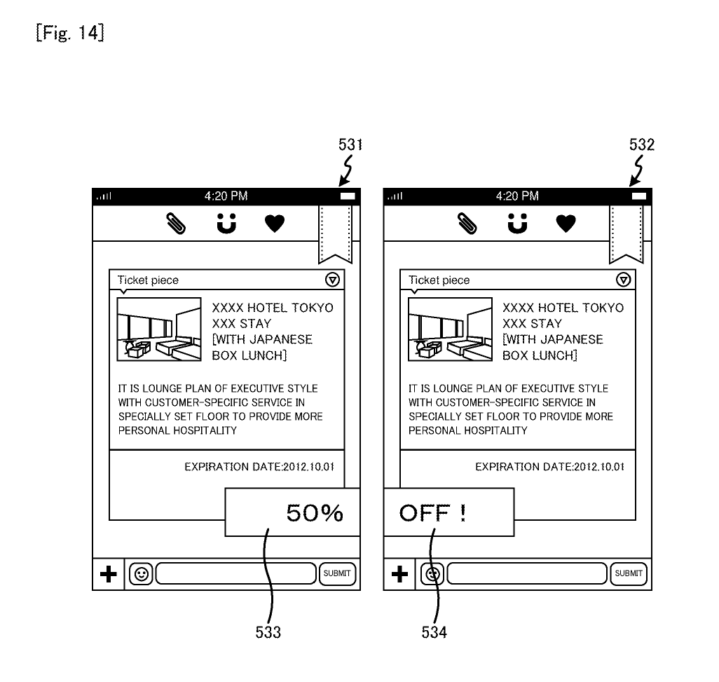

Returning to FIG. 8, in the mobile terminal 10, the coupon receiving unit 125 receives the divided coupon (S416) and the coupon display unit 126 display the divided coupon (S417). FIGS. 14 to 16 are diagrams to describe a state where divided coupons are displayed. FIG. 14 illustrates an example of the screens 531 and 532 displayed to two mobile terminals 10, where a divided coupon 533 of “50%” is displayed on the screen 531 displayed to one mobile terminal 10 and a divided coupon 534 of “OFF!” is displayed on the screen 532 displayed to the other mobile terminal 10. Therefore, coupon content “50% OFF” turns out only after these two mobile terminals 10 are arranged. Since two mobile terminals 10 are in the same place, it become possible to display the entire coupon by arranging the screens 531 and 532 in this way.

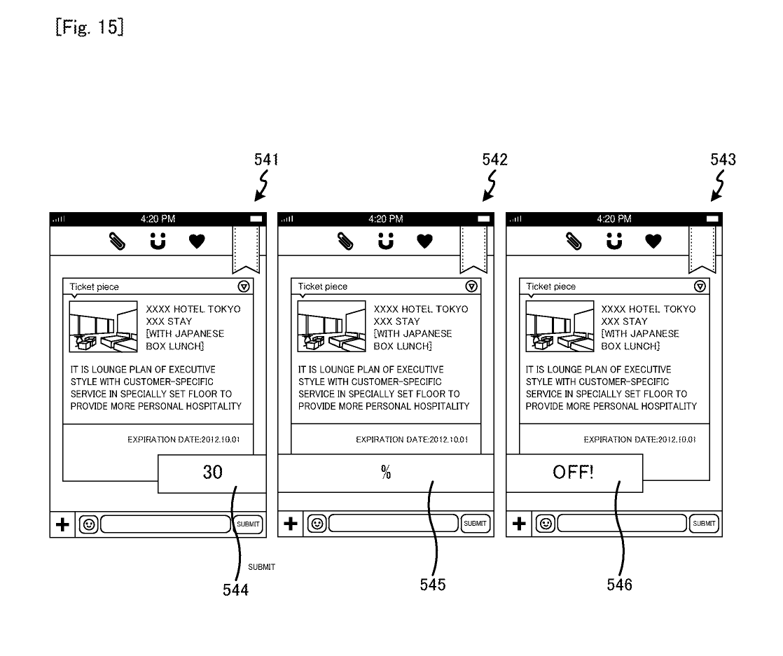

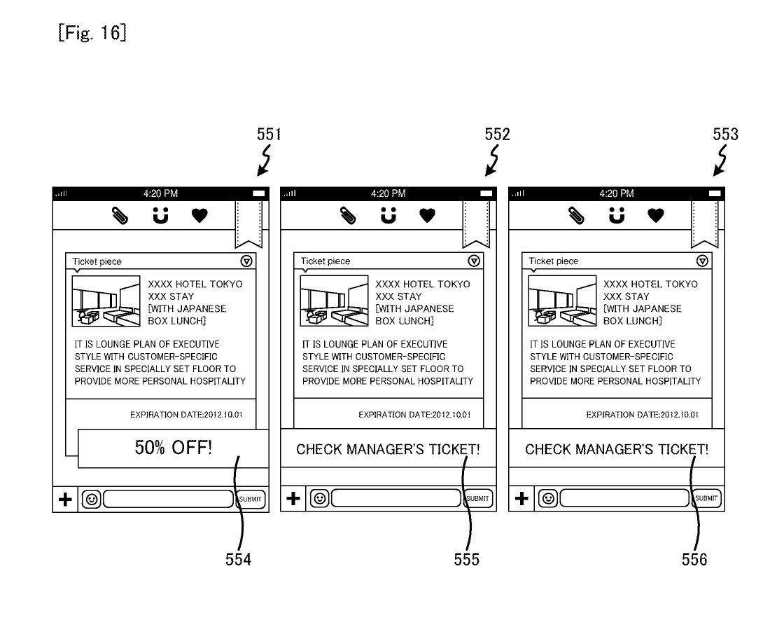

Moreover, FIGS. 15 and 16 illustrate examples of screens displayed to three mobile terminals 10, FIG. 15 illustrates an example where part of a coupon is displayed to each mobile terminal 10 in a similar way to FIG. 14, and FIG. 16 illustrates an example where the whole of a coupon is displayed to the mobile terminal 10 of the representative user and none of the content of the coupon is displayed to other mobile terminals 10. In FIG. 15, a divided coupon 544 of “30” is displayed on a screen 541 displayed to the first mobile terminal 10, a divided coupon 545 of “%” is displayed on a screen 542 displayed to the second mobile terminal 10, and a divided coupon 546 of “OFF!” is displayed on a screen 543 displayed to the third mobile terminal 10. Therefore, coupon content “30% OFF” turns out only after these three mobile terminals 10 are arranged. Even in the example of FIG. 15, it becomes possible to display the whole of the coupon by arranging three mobile terminals 10 in a similar way. Meanwhile, in FIG. 16, the whole of a coupon is displayed as a divided coupon 554 on a screen 551 displayed to the mobile terminal 10 of the representative user, and messages 555 and 556 to give an instruction to view the screen of the representative user (manager) are displayed on screens 552 and 553 displayed to the mobile terminals 10 of other users. By this means, other members than the representative user can understand the content of the coupon by seeing the screen 551 of the mobile terminal 10 of the representative user in the same place.

### ==Effect==

As described above, according to the coupon distribution system of the present embodiment, it is possible to issue a coupon to a group of multiple users. Therefore, it becomes possible to promote a commodity and service to a group as a unit. Consequently, it becomes possible to improve the advertising effect and the customer collection effect and so forth using the coupon. Moreover, it comes to provide a commodity and service related to the coupon as a common topic between the users in the group, and it is possible to activate communication between the users.

Moreover, since a coupon notification in a folded form is displayed as illustrated in FIG. 9 in the coupon distribution system of the embodiment, it is possible to prevent the coupon notification from completely interrupting the execution of a program, such as a messenger program.

Moreover, since a coupon notification arrives at each of users who are performing a chat at the same time in the coupon distribution system of the present embodiment, in a case where coupon content attracts the interest, it is expected that the coupon as a topic is communicated between the users. By this means, it is possible to activate the communication between the users. Moreover, it is assumed that the motivation to use a coupon becomes large when communication is performed, and therefore it is possible to improve the advertising effect and customer collection effect with respect to an object of the coupon.

Moreover, in the coupon distribution system of the present embodiment, since a coupon is transmitted only to the mobile terminal 10 having transmitted a coupon reception request according to a coupon notification, it is possible to positively distribute the coupon to the user with a strong intention to use the coupon. Therefore, it becomes possible to further improve the customer collection effect and the advertising effect using the coupon.

Moreover, in the coupon distribution system of the present embodiment, among mobile terminals 10 having transmitted a coupon reception request according to a coupon notification, it is possible to distribute a coupon only to the one existing in a determination range based on a reference position. Therefore, since it is possible to reliably distribute the coupon to the mobile terminal 10 existing in the same place, it is possible to further improve the customer collection effect and the advertising effect using the coupon. Moreover, since the user with a strong intention to use the coupon exists in the same place, there is a high possibility that a topic related to the coupon is orally taken up in a direct manner. By this means, user's communication is activated and a word-of-mouth effect by the user can be expected.

Moreover, in the coupon distribution system of the present embodiment, it is possible to transmit a divided coupon to each user without duplication. Since the user having received the divided coupon has to see the screens of all group members together (only persons having transmitted a coupon reception request in the embodiment) to see the content of the entire coupon, the users in the group are expected to act to decipher the content of the entire coupon in cooperation, and, by this means, it is possible to improve a sense of solidarity between users belonging to the group.

### Modification Example

Here, the coupon distribution system of the present embodiment is premised on the distribution of a coupon, but it is not limited to this, and it can be used as a system that distributes information in which some privileges are expressed. For example, the coupon distribution system of the present embodiment can be operated as a system that distributes a ticket such as an admission ticket to the movie theater, distributes a gold note such as a gift certificate and distributes a key to access the Web service. Even in this case, information in which various privileges as mentioned above are expressed is transmitted to each reception terminal as divided information which are divided. For example, in a case where the reservation number is issued as a ticket, it is possible to divide a character string expressing the reservation number and perform transmission.

Moreover, a coupon is assumed to be a character string in the present embodiment, but it is not limited to this, and it may be a still image and a moving image, and so forth. For example, an image encoding the content of the coupon in a form of bar code or QR code (registered trademark) may be prepared to divide this image and transmit a divided coupon. In this case, when an encoded image such as a bar code and a QR code (registered trademark) cannot be read at the time screens on which the image is displayed are arranged, it is preferable to set the user ID to the representative user of group information, transmit the encoded image only to the representative user and transmit a message to give an instruction to refer to the screen of the presentative user, to other members.

Moreover, in the embodiment, a divided coupon is assumed to be distributed, among mobile terminals 10 having transmitted a coupon reception request according to a coupon notification, only to the one whose current position is included in a determination range, but it is not limited to this. Divided coupons divided according to the number of users belonging to a group may be directly transmitted to mobile terminals 10 of the users belonging to the group without requesting the reception of the coupon notification or the coupon reception request according thereto, or all of mobile terminals 10 having transmitted a coupon reception request according to a coupon notification may be determined as reception terminals without place limitation. Even in this case, since the user cannot understand the content of the coupon unless all of users belonging to the group come together, it is possible to give motivation such that the users come together in the same place, it becomes possible to distribute a coupon for multiple users who come together in the same place in this way, and it becomes possible to improve a sense of solidarity between the users and activate communication between the users.

Moreover, a range within a predetermined distance centering on a reference position (predetermined position or current position of the representative user) is assumed to be a determination range in the present embodiment, but it is not limited to this. For example, a polygon expressed by three or more latitude/longitude points may be included in coupon information as information showing the determination range, and whether the current position of each mobile terminal 10 is included in this polygon may be decided.

Moreover, in the present embodiment, it is assumed that the whole of a coupon is necessarily transmitted only to a representative user in a case where the representative user is set, but, for example, a flag showing whether to transmit the coupon only to the representative user may be included in coupon information and processing may diverge according to the flag in step S434 of FIG. 13.

Moreover, the distribution server 20 is assumed to be one computer in the embodiment, but, it is not limited to this, and it may be configured with multiple computers. For example, one virtual computer can be formed with multiple computers, or at least one of the group database 241, and the coupon database 242 may be managed by another database server such that the distribution server 20 accesses the database server.

Moreover, the measurement of the position of the mobile terminal 10 is assumed to use GPS in the embodiment, but it is not limited to this, and, for example, GNSS (Global Navigation Satellite System) different from GPS may be used, or the measurement may be performed using a giro, an acceleration sensor and Bluetooth (registered trademark), and so forth, in addition to GPS or in place of GPS. Moreover, the mobile terminal 10 may not specify its own position, and the distribution server 20 may record the positions of routers, base stations and so forth beforehand, identify a router, a base station and so forth accessed by the mobile terminal 10, and, from the position thereof, estimate the position of the mobile terminal 10. That is, it is possible to use an arbitrary technique if it is possible to measure the position of the mobile terminal 10.

Moreover, the coupon notification transmission unit 221 accepts the identification of a group in the present embodiment, but it is not limited to this, and the coupon notification transmission unit 221 may determine a group to which a coupon is distributed. In this case, for example, it is possible to register the attribute of the user or group in the distribution server 20 beforehand and determine a group of coupon distribution destination according to this attribute.

The embodiment has been described above, but the above-mentioned embodiment is provided to facilitate the understanding of the present invention, and is not provided to limit the interpretation of the present invention. The present invention may be changed and improved without departing from the scope, and its equivalent may be included in the present invention.

### REFERENCE SIGNS LIST

10 Mobile terminal
20 Distribution server
30 Communication network
121 Coupon notification receiving unit
122 Coupon reception instruction input unit
123 Positioning unit
124 Coupon reception request transmission unit
125 Coupon receiving unit
126 Coupon display unit
221 Coupon notification transmission unit
222 Coupon reception request receiving unit
223 Reception terminal determination unit
224 Coupon creation unit
225 Coupon dividing unit
226 Coupon transmission unit
241 Group database
242 Coupon database

1. A privilege providing device for providing a privilege to be given to multiple users, comprising:
a privilege information storage unit configured to store privilege information that is information to express the privilege to be given to the users; and
a privilege information transmission unit configured to transmit to each of user terminals of the users divided information into which the privilege information is divided according to a number of the users.

2. The privilege providing device according to claim 1, further comprising:
a notification transmission unit configured to transmit to the user terminals a notification to give the privilege to the users; and
a reception request receiving unit configured to receive reception requests of the privilege, the reception requests transmitted from the user terminals in response to the notification,
wherein the privilege information transmission unit specifies reception terminals that are the user terminals having transmitted the reception requests, divides the privilege information according to a number of the reception terminals, and transmits the divided information only to the reception terminals.

3. The privilege providing device according to claim 2,
wherein the privilege information transmission unit transmits the divided information only when the number of the reception terminals is equal to or greater than a predetermined number.

4. The privilege providing device according to claim 3, wherein:
the privilege information storage unit stores the privilege information that varies according to a division number; and
the privilege information transmission unit reads out the privilege information corresponding to the number of the reception terminals from the privilege information storage unit and divides the read privilege information according to the number of the reception terminals.

5. The privilege providing device according to claim 2, wherein:
positions of the user terminals are included in the reception requests; and
the privilege information transmission unit
determines whether the positions included in the reception requests are included in a predetermined range based on a predetermined position, and
specifies, among the user terminals having transmitted the reception requests, the user terminals whose positions are included in the predetermined range as the reception terminals.

6. The privilege providing device according to claim 1,
wherein the privilege information transmission unit transmits a whole of the privilege information only to one first user terminal among the multiple user terminals, and transmits a message to give an instruction to view the privilege information displayed to the first user terminal, to a second user terminal different from the first user terminal.

7. The privilege providing device according to claim 1, further comprising:
a notification transmission unit configured to transmit to each of the user terminal a notification to give the privilege; and
a reception request receiving unit configured to receive reception requests of the privilege, the reception requests being transmitted from the user terminals in response to the notification and including positions of the user terminals,
wherein the privilege information transmission unit
determines whether the positions included in the reception requests are included in a predetermined range based on a position of a first user terminal, and
specifies, among the user terminals having transmitted the reception requests, the user terminals whose positions are included in the predetermined range as the reception terminals.

8. A method of providing a privilege to multiple user terminals, the method comprising steps executed by a computer of:
storing privilege information that is information to express the privilege to be provided to the user terminals; and
transmitting to each of the user terminals without duplication divided information into which the privilege information is divided according to a number of the user terminals.
